(19) United States
(12) Patent Application Publication
(10) Pub. No.: US 2016/0272457 A1
(43) Pub. Date: Sep. 22, 2016

(54) FOLDING MODULE FOR A MACHINE FOR PRODUCING MAILING COVERS AND RESULTING MACHINE

(71) Applicant: ACTI MEDIAS Sociètè par actions simplifiée, Toulouse (FR)

(72) Inventors: Julien BLANC, Limoges (FR); Charles DECK, Muret (FR); Thierry FREBOURG, Aix les Bains (FR); Jean-Claude PRENEL, Sacquenville (FR)

(73) Assignee: ACTI MEDIAS Socièté par actions simplifièe, Toulouse (FR)

(21) Appl. No.: 15/030,935

(22) PCT Filed: Oct. 20, 2014
(86) PCT No.: PCT/IB2014/002170

§ 371 Date: Apr. 21, 2016

(30) Foreign Application Priority Data
Oct. 21, 2013 (FR) 13/60252

(51) Int. Cl. B65H 45/18; B65B 63/04; B43M 3/00; B43M 5/04; B31B 1/56; B31B 21/00

(52) U.S. Cl. CPC B65H 45/18; B31B 1/56; B31B 21/00; B43M 3/00; B43M 5/04; B65B 63/04; B31B 2219/2654; B31B 2219/6007; B65H 2701/1916

(57) ABSTRACT

A folding module (13) intended for a machine (1) for producing mailing covers, comprising two counter-rotating folding rollers (18a, 18b) defining a zone (ZR) for receiving at least one envelope document, an entry zone (20) and an exit zone (ZS) from which the envelope document, folded according to a predefined folding line, exits. A pushing mechanism (22) is movable in translation perpendicularly to receiving zone (ZR) between a passive position and an active position in which the pushing mechanism (22) moves the envelope document from the receiving zone (ZR) into the entry zone (20). A pushing roller (22′), mounted free in rotation at the end of the pushing mechanism (22), accompanies, in the active position, the envelope document (4) without sliding until the envelope document enters into contact with one of folding rollers (18a, 18b) thus ensuring high folding accuracy.

### TECHNICAL SCOPE

This invention relates to a folding module intended for a machine for producing mailing covers, this folding module being arranged for folding in two at least one envelope document made of a front and a back delimited by a folding line, one at least of the front or of the back comprising straight side edges or side flaps, said folding module comprising at least a first and a second counter-rotating folding roller pressing on each other along a generating line to delimit on one side of said folding rollers a receiving zone for said envelope document tangent to said folding rollers, followed by an entry zone between the folding rollers, in which the envelope document is introduced, and on the other side an exit zone between the folding rollers, from which the envelope document folded in two exits, said folding module comprising moreover a pushing means movable in translation above and perpendicularly to the receiving zone between a passive position in which it is away from the receiving zone and an active position in which it moves said envelope document from said receiving zone inside of said entry zone above said folding line.

This invention also relates to a machine for producing at least one mailing cover comprising at least one envelope document made of a front and of a back delimited by a folding line, one at least of the front or of the back comprising straight side edges or side flaps.

### PRIOR ART

Machines for producing mailing covers are already used by bodies wishing to send large quantities of mailing covers. These machines have the advantage of producing both envelopes and corresponding documents and then forming closed mailing covers ready for dispatch. Large-scale dispatch of mailing covers therefore requires machines that allow producing mailing covers as quickly and efficiently as possible. It is also desirable to obtain mailing covers whose envelope has a satisfactory aesthetic finish and comes as close as possible to that of individually produced envelopes. In fact, such envelopes generally consist in envelopes whose side flaps are not visible. They are formed from a substantially rectangular sheet folded in two to form the front and the back of the envelope and comprising two side flaps located on either side of the front of the envelope and a closing flap located along the end of the front. For example, to form the envelope, one folds the two side flaps towards the inside of the envelope, one applies glue either on the side flaps folded on the font or on the straight side edges of the back, then one folds the front down on the back of the envelope or vice-versa to dose the envelope laterally. Glue is then applied on the closing flap, which is folded on the back to seal the envelope.

Many industrial machines for producing mailing covers allow forming covers without side flaps, whose aesthetic is not satisfactory. Publication US 2012/0260605 A1 for example discloses a machine for producing mailing covers formed by envelopes without side flaps. The machine comprises a first line for creating a content document having a size compatible with that of the envelope and a second line for forming an envelope document and applying glue on the side flaps of the envelope document. The first and the second lines are operating in parallel. A third line, at the exit of the first and second lines, allows assembling perpendicularly the envelope document and the content document and folding the envelope document in two around the content document, then activating the glue on the side edges of the envelope document with two superimposed pressure rollers. Even if such machine has the advantage of being usable at high rates, it does not allow producing envelopes with side flaps and, moreover, which would not be apparent.

Today, machines for producing mailing covers at a large scale already allow obtaining envelopes with non-apparent side flaps. U.S. Pat. No. 5,640,831 A1 is known as such, and describes a machine for forming mailing covers made of envelopes provided with side flaps. The machine comprises a first line for forming the content documents to be inserted at the size of the envelope and a second line for forming a strip of envelopes from a roll. The second line therefore allows obtaining a strip of attached envelopes in which side flaps and windows are cut out. The machine then allows assembling the content documents on the strip of envelopes on a third line. First of all, a fold-down module folds the side flaps of the strip of envelopes towards the inside by means of deflectors, then it cuts transversally the strip of envelopes at the proper length to separate the envelope documents. A glue application module then applies glue on the side edges of the back. Finally, a folding module allows folding the envelope module in two around the content document and folding the back down on the front by means of deflectors. Indeed, this machine is complex, large and expensive, as it requires two lines in parallel to produce on the one hand the content documents and on the other hand the envelope documents. Therefore error risks when assembling the mailing covers are not excluded, which requires a very expensive mailing cover integrity control method. Moreover, in case of jamming for example, the restarting cycle of the machine is particularly long.

U.S. Pat. No. 4,189,895 also discloses a machine for producing mailing covers according to a continuous method. The mailing cover is obtained from an envelope document and from a content document formed from a same sheet of paper. The content document is folded on the envelope document to which it remains attached. Then strips of glue are placed along the side edges of the envelope document by a glue application module. The envelope document is then folded in two along a folding, line around the folded content document by means of a folding module. This folding module comprises in particular two parallel counter-rotating rollers pressing on each other along a generating line to define an entry zone. It moreover comprises a folding blade movable in translation perpendicularly to the plane defined by the two rollers and aligned with the entry zone. When the envelope document reaches the two rollers and is positioned by a translation stop in order to center the folding line on the entry zone, the folding blade moves down over the folding line and introduces it in the entry zone of the rollers, which then take over the envelope document and close the mailing cover laterally by pressing the front on the back of the envelope document and then evacuate it. This results in an envelope document folded around a folded content document, which is attached to the envelope document. The disadvantage of such a folding module is due to the fact that the folding blade, also called knife, can drag along and fold only one layer of paper. This is particularly restricting when mailing covers containing several content documents, which moreover are separated from the envelope document and offset with respect to the folding line, are to be produced.

A machine is known from U.S. Pat. No. 3,193,983 that allows folding sheets and inserting them in an envelope to form a mailing cover, which is not the subject of this invention, as the envelopes are produced independently and the content document is inserted in the finished envelope,

A machine for folding sheet is described in publication EP 0 795 507. The machine comprises two folding rollers placed one against the other and two pressure rollers arranged below these two folding rollers. The pressure rollers are movable in translation perpendicularly to the folding rollers. The sheet to be folded is guided flat up to a atop, then it is folded in its center by the pressure rollers movable in translation that push the sheet by its center between the two folding rollers. A similar machine for folding sheet is also described in publication DD 101 875. The machine comprises a guiding element movable in translation and arranged above and between the two pressure rollers. The translation movement of the guiding element, which is perpendicular to the direction of the sheet, allows introducing it by its center between the two folding rollers to fold it in two. Such machines however do not allow folding one or more content documents superimposed on an envelope document, which would create a heterogeneous set of documents to be folded. In fact, the pushing means comprises two pressure rollers mounted on a same support to exert a same pressure on each of the folding rollers. They therefore are not free with respect to each other for managing the thickness differences in a same set of documents to be folded, that is to say between the folder roller and the pressure roller pairs. Folding such heterogeneous documents would be doomed to failure.

### DESCRIPTION OF THE INVENTION

The present invention aims to remedy these disadvantages by offering a folding module that allows folding with high accuracy several sheet layers such as an envelope document around one or several separated content documents offset with respect to the folding line, which create an heterogeneous set of documents to be folded. Another goal of the invention is to realize a machine for producing mailing covers arranged for creating an envelope comprising invisible side flaps that operates at industrial pace.

To that purpose, the invention relates to a folding module of the kind described in the preamble, characterized in that it comprises at least one pushing roller mounted free in rotation at the end of said pushing means in order to accompany in active position said envelope document until it enters into contact with one of the folding rollers to allow said folding rollers to take over said envelope document, and in that said pushing means is out of center with respect to said entry zone, so that said pushing roller only enters into contact with one of said folding rollers.

In a preferred embodiment, the folding module comprises a stop arranged for stopping the movement of the envelope document and aligning the folding line of the envelope document with the entry zone between the folding rollers. The stop may be a mechanical stop arranged at the end of the receiving zone and/or an electrical stop.

In another embodiment variant of the invention, the folding module is arranged for folding in two at least one envelope document around at least one content document superimposed on the front or on the back of said envelope document and said pushing roller is arranged to accompany in active position said envelope document and said content document until they enter into contact with one of the folding rollers.

In this case, said pushing means is located above said first folding roller so that, in active position, said pushing roller enters into contact with said first folding roller.

It may include a glue application module arranged to apply at least two strips of glue on the side edges or on the side maps of the front and/or of the back during the movement of the envelope document before and/or while folding it.

Moreover, said glue application module may comprise two glue application nozzles arranged to be located in front of the side edges or of the side flaps of the front and/or of the back and to apply simultaneously at least two strips of glue on the side edges or on the side flaps of the front and/or of the back when they pass in front of said glue application nozzles. This glue application module may be located substantially above said second roller and be fixed.

The invention also relates to a production machine of the kind described in the preamble, characterized in that it comprises the above-described folding module.

In a preferred embodiment variant, it comprises a first routing module and a second routing module arranged in parallel and upstream of said folding module and arranged for forwarding respectively at least one content document and at least one envelope document.

It may comprise an assembling module located downstream of said routing modules and upstream of said folding module, arranged for assembling said at least one content document on said envelope document.

It may moreover comprise a glue application module located upstream or downstream of said folding module and arranged for applying at least one strip of glue respectively on the side edges or on the side flaps of said envelope document and a fold-down module integrated in said assembling module and arranged for folding down towards the inside the side flaps of said envelope document.

### BRIEF DESCRIPTION OF THE DRAWINGS

The present invention and its advantages will be better revealed in the following description of an embodiment given as a non limiting example, in reference to the drawings in appendix, in which:

FIG. 1 represents a sectional side view of a machine for producing mailing covers according to the invention,

FIG. 2 is a schematic perspective view of the method for producing mailing covers implemented by the machine of FIG. 1, and

FIGS. 3A, 3B and 3C are simplified perspective views of the glue application and folding modules of the machine of FIG. 1.

### ILLUSTRATIONS OF THE INVENTION AND BEST WAY OF REALIZING IT

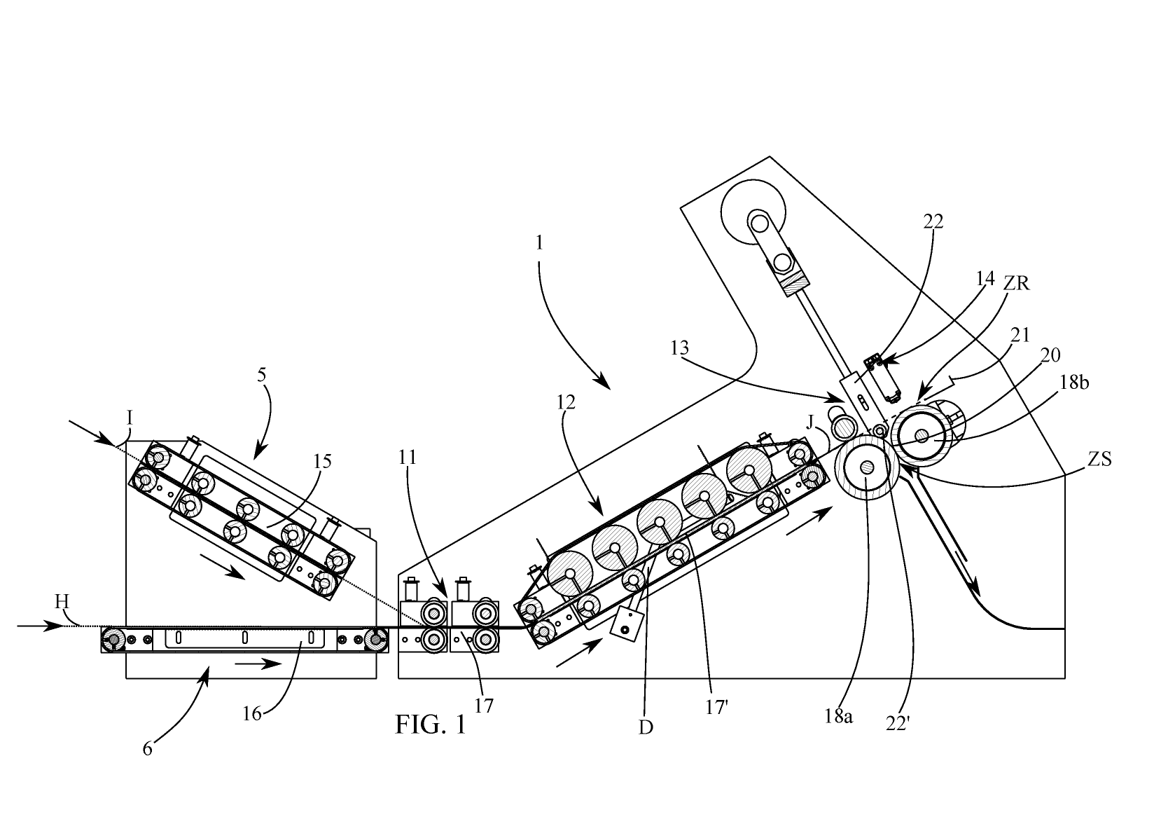

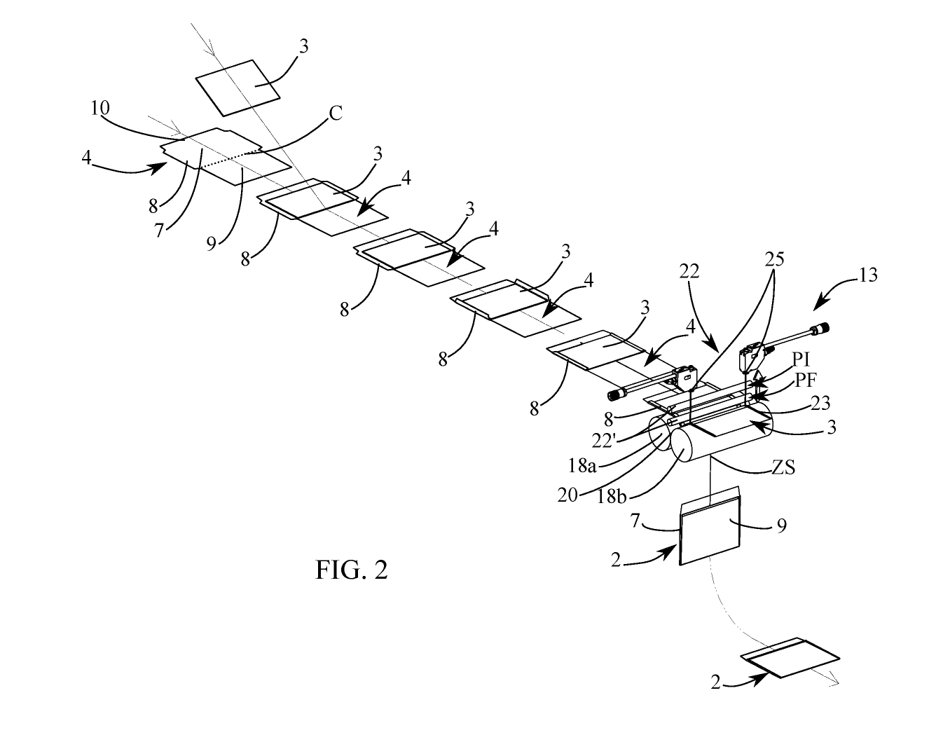

Referring to FIGS. 1 and 2, production machine 1 allows producing mailing covers 2 with a variable content, identical or different, obtained from an envelope document 4 assembled or not with one or several content documents 3 folded at the format of the finished envelope and superimposed on envelope document 4. Machine 1 comprises a first routing module 5 for forwarding content documents 3 and a second routing module 6 for forwarding envelope documents 4, forming two separated and superimposed circuits, up to an assembly module 11. Machine 1 also comprises a fold-down module 12 followed by a folding module 13 and finally by a glue application module 14.

As shown in FIG. 2, content document 3 may be a sheet, for example out of paper or similar, and having a rectangular shape. Of course, content document 3 is not restricted by this choice of material or shape. Moreover, content document 3 has a size compatible with envelope document 4, that is to say that the dimensions of content document 3 are smaller than the dimensions of envelope document 4. From this results that envelope document 4 can contain content document 3 to form a mailing cover 2. Upstream of machine 1, content documents 3 may be obtained either from a sheet of material, for example paper, or from a strip of material prepared on a roll or in a coil, for example paper. From a sheet or a roll, it is possible to create one or several content documents 3 on a same paper width. Content documents 3 may also be printed on line or not. The content documents 3 created this way are then inserted in machine 1. According to their number and dimension, content documents 3 may be stacked to form a bundle and folded for example with 1 or 2 folds to correspond to the format of the finished envelope.

To that purpose, a first routing module 5 is provided at the entry of machine 1 for receiving content documents 3 and forwarding them up to assembling module 11 as shown in FIG. 1. The first routing module 5 is located above the second routing module 6 for placing at a later point content documents 3 on envelope documents 4 and superimposing them. The first routing module 5 is inclined along inclined plane 1, for example by an angle comprised between 25 and 35 degrees, preferably equal to 30 degrees, with respect to horizontal plane H, without these values being limiting. It may in particular be made of a double conveyor 15 arranged for maintaining and forwarding content documents 3 along inclined plane I up to assembling module 11.

Envelope document 4 may consist in a sheet, for example out of paper, having a substantially rectangular shape, comprising a front 7 and a back 9 delimited by a folding line C, the front 7 is represented in the example provided with two side flaps 8 and with a closing flap 10 at its free end, as shown in FIG. 2. Of course, envelope document 4 is not restricted by this choice of material or shape. For example, envelope document 4 can have no side flaps 8 and simply have straight side edges. As for content documents 3, envelope documents 4 may be obtained either from a sheet of material, for example paper, or from a strip of material prepared on a roll or in a coil, for example paper. From a sheet or a roll, it is possible to create one or several envelope documents 4 on a same paper width. Envelope documents 4 may also be printed on line or not, in particular in order to receive information related to the addressee of the mailing cover, both outside and inside envelope document 4. The envelope documents 4 created this way are also inserted in machine 1. They are placed so that back 9 of every envelope document 4 is inserted first in machine 1, as shown in FIG. 2.

To do so, a second routing module 6 is provided at the entry of machine 1. This second routing module 6 may be a simple horizontal vacuum conveyor 16 along plane H, as shown in FIG. 1. It is located underneath first routing module 5 and is arranged for receiving envelope documents 4 and forwarding them up to assembling module 11.

Assembling module 11, as it is represented in FIG. 1, allows bringing together content documents 3 and envelope documents 4. It may be formed by a double conveyor 17 located at the exit of the first and second routing modules 5, 6. More specifically, assembling module 11 is located substantially at the intersection of inclined plane I and horizontal plane H along which said routing modules 5 and 6 extend. Such assembling module 11 is arranged for placing one or several content documents 3 on the front 7 of an envelope document 4 as illustrated in FIG. 2.

A fold-down module 1 is placed at the exit of assembling module 11. It comprises in particular a double conveyor 17 arranged for maintaining and forwarding the superimposed content documents 3 and envelope document 4 up to folding module 13 along a plane J inclined for example by an angle comprised between 25 and 35 degrees, preferably equal to 30 degrees, with respect to horizontal plane H, without these values being limiting. This fold-down module 12 moreover comprises side deflectors D that allow folding down and folding side flaps 8 of envelope document 4 on content documents 3, as shown in FIG. 2.

A folding module 13 is located at the exit of fold-down module 12 as shown in FIGS. 1 and 2. It comprises two adjacent folding rollers 18a, 18b, separated by an entry zone 20. In particular, folding rollers 18a, 18b comprise a first roller 18a and a second roller 18b, which rotate in, opposite directions, they are called counter-rotating. More specifically, only one of the rollers is driven by a motorization, it drives the other roller in the opposite direction by contact under pressure along a common generating line. Their axes are comprised in a plane parallel to the displacement plane of envelope documents 4 and content documents 3. Folding rollers 18a, 18b form on one side and more specifically in their upper section, a receiving area ZR of said envelope documents 4 and content documents 3, this receiving zone ZR being tangent to said folding rollers 18a, 18b. Folding module 13 also includes a stop that allows stopping the movement of envelope document 4 to position accurately folding line C of envelope document 4 vertically above entry zone 20 located between the adjacent folding rollers 18a, 18b. This stop may be a translation stop 21 located at the end of receiving zone ZR. In this case, envelope document 4 is stopped mechanically by translation stop 21 that opposes the movement of envelope document 4. According to another variant, it may also consist in an electrical stop (not represented) that allows detecting with high accuracy the position of envelope document 4 and stopping the movement of envelope document 4 without using a mechanical stop for the sheet. This electrical stop may include an optical sensor using for example a LED for detecting the front edge of envelope document 4, then a counter for accurate positioning by counting the number of motor revolutions according to the format of the paper. This results in a positioning accuracy for envelope document 4 of the order of the millimeter. Moreover, this choice of an electrical stop is particularly suitable when several content documents 3 are superimposed on envelope document 4, as there is no physical contact with envelope document 4.

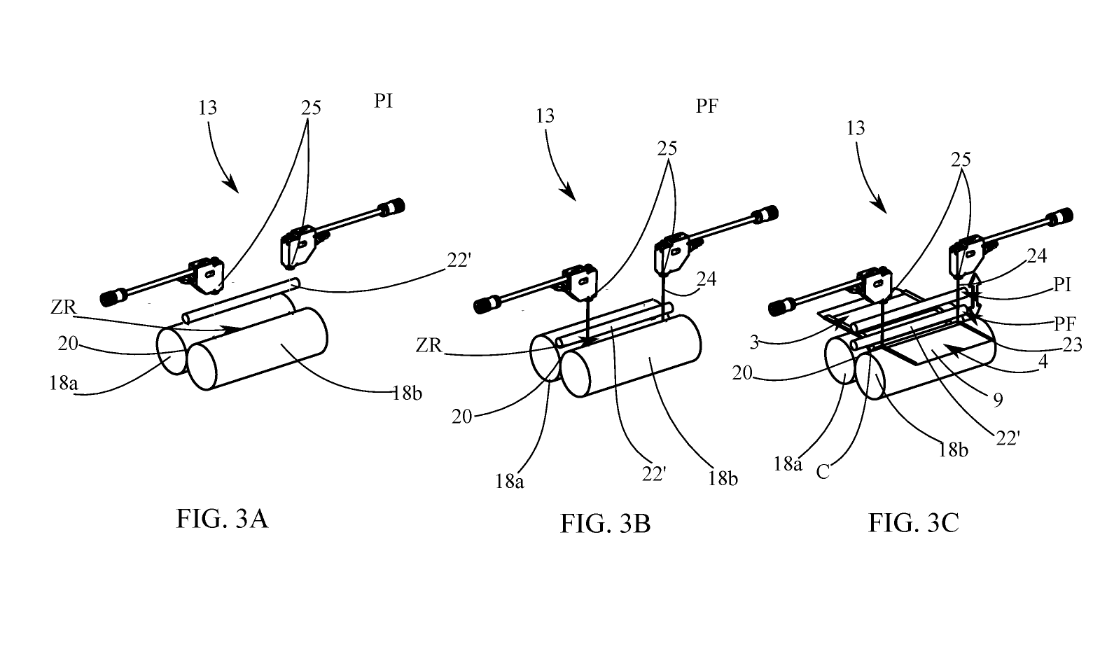

In addition, folding module 13 comprises a pushing means 22 located above the two folding rollers 18a, 18b. More specifically, pushing means 22 comprises a rotating roller 22′ mounted free in rotation at the end of pushing means 22. Pushing means 22 is movable in translation perpendicularly to receiving zone ZR between a passive position PI and an active position PF. As shown in FIG. 3A, in upper passive position PI, pushing means 22 exerts no force on envelope document 4, which is away from receiving zone ZR. In an active lower position PF, pushing means 22 exerts a force on envelope document 4 and moves it from receiving zone ZR towards entry zone 20, as shown in FIGS. 3B and 3C. Moreover, pushing means 22 is offset or out of center with respect to entry zone 20. Pushing means 22 is advantageously not placed in the vertical alignment of entry zone 20. Such configuration allows that, in active position PF, the rotating roller 22′ pushes on envelope document 4 alone or simultaneously on envelope document 4 and on content documents 3 to hold them on each other without sliding, and to move them to bring them into contact with first folding roller 18a located upstream of entry zone 20. Another advantage of such arrangement is that rotating roller 22′ allows folding an heterogeneous set of documents formed of several paper layers, and in particular content documents 3 offset with respect to folding line C of envelope document 4, which is not the case when using a folding blade according to the prior art. In addition, such rotating roller 22′ allows guiding and moving folding line C of envelope document 4 towards entry zone 20 by pushing it. Folding line C is then dragged along in entry zone 20 by the two folding rollers 18a, 18b. Then envelope document 4 alone or envelope document 4 with content documents 3 exits on the other side of folding rollers 18a 18b, and more specifically in a lower section forming an exit zone ZS, towards a finishing module (not represented) for mailing cover 2.

A glue application module 14 is also provided close to folding module 13. As shown in FIG. 3C, glue application module 14 is fixed and comprises two glue application nozzles 25 arranged respectively in front of the two side edges 23 of back 9. Such glue application module 14 is located substantially above second folding roller 18b and is arranged to apply respectively two strips of glue 24 on side edges 23 of back 9. It is also possible to provide a glue application module located before first roller 18a, for example for gluing the side edges or the side flaps 8 of front 7 and/or the side edges 23 of back 9. More specifically, when folding line C of envelope document 4 is dragged along in entry zone 20, side edges 23 of back 9 pass in front of nozzles 25 from folding line C towards end of back 9. From this results that nozzles 25 apply strips of glue 24 along these side edges 23 from folding line C towards end of back 9. Back 9 and front 7 of envelope document 4 are pressed progressively on each other by the two folding rollers 18a, 18b, around content document(s) 3, when passing from entry zone 20 to exit zone ZS. This results in gluing side edges 23 of back 9 on side flaps 8 of front 7 folded towards the inside. Consequently, at the level of exit zone ZS of folding module 13, a mailing cover 2 closed laterally, but open longitudinally, that is to say whose closing flap 10 is not glued, is formed.

Advantageously, the combination of folding module 13 and gluing module 14 allows applying glue on side edges 23 of back 9 when folding envelope document 4 around content document(s) 3. This results in a fast and efficient pace suitable for industrial production of mailing covers 2.

### POSSIBILITIES FOR INDUSTRIAL APPLICATION

This description shows clearly that the invention allows reaching the goals defined, that is to say folding with high accuracy several sheet layers such as an envelope document around separated content documents offset with respect to the folding line, and obtaining a quality mailing cover whose envelope shows invisible side flaps, at a fast industrial pace.

The present invention is not restricted to the example of embodiment described, but extends to any modification and variant which is obvious to a person skilled in the art while remaining within the scope of the protection defined in the attached claims.

1-14. (canceled)

15. A folding module (13) intended for a machine (1) for producing mailing covers (2), the folding module (13) being arranged for folding in two at least one envelope document (4) made of a front (7) and a back (9) delimited by a folding line (C), one at least of the front (7) or the back (9) comprising straight side edges or side flaps (8), the folding module (13) comprising at least first and second counter-rotating folding rollers (18a, 18b) pressing on each other along a generating line to delimit, on one side of the folding rollers (18a, 18b), a receiving zone (ZR) for the envelope document (4) tangent to the folding rollers (18a, 18b), followed by an entry zone (20) between folding rollers (18a, 18b) in which envelope document (4) is introduced, and, on the other side, an exit zone (ZS) between folding rollers (18a, 18b), from which envelope document (4) folded in two exits, the folding module (13) comprising a pushing means (22) movable in translation above and perpendicularly to receiving zone (ZR) between a passive position (P1) in which the pushing means (22) is away from receiving zone (ZR) and an active position (PF) in which the pushing means (22) moves the envelope document (4) from the receiving zone (ZR) inside of the entry zone (20) above the folding line (C),
wherein the folding module (13) comprises at least one pushing roller (22′) mounted free in rotation at the end of the pushing means (22) in order to accompany in active position (PF) the envelope document (4) until the envelope document (4) enters into contact with one of folding rollers (18a, 18b) to allow the folding rollers (18a, 18b) to take over the envelope document (4), and the pushing means (22) is out of center with respect to the entry zone (20) so that the pushing roller (22′) only enters into contact with one of the folding rollers (18a, 18b).

16. The folding module according to claim 15, wherein the folding module comprises a stop (21) arranged for stopping the movement of envelope document (4) and aligning folding line (C) of envelope document (4) with entry zone (20) between folding rollers (18a, 18b).

17. The folding module according to claim 16, wherein the stop is a translation stop (21) located at the end of receiving area (ZR).

18. The folding module according to claim 16, wherein the stop is an electrical stop.

19. The folding module according to claim 15, arranged for folding in two at least one envelope document (4) around at least one content document (3) superimposed on the front (7) or on the back (9) of the envelope document (4), wherein the pushing roller (22′) is arranged to accompany, in the active position (PF), the envelope document (4) and the content document (3) until they enter into contact with one of the folding rollers (18a, 18b).

20. The folding module according to claim 15, wherein the pushing means (22) is located above the first folding roller (18a) so that, in the active position (PF), the pushing roller (22′) enters into contact with the first folding roller (18a).

21. The folding module according to claim 15, wherein the folding module includes a glue application module (14) arranged to apply at least two strips of glue (24) on side edges (23) or on side flaps (8) of the front (7) and/or the back (9) during the movement of the envelope document (4) before and/or while folding the envelope document (4).

22. The folding module according to claim 21, wherein the glue application module (14) comprises two glue application nozzles (25) arranged to be located in front of side edges (23) or side flaps (8) of the front (7) and/or the back (9) and to apply simultaneously two strips of glue (24) on the side edges or on the side flaps (8) of the front (7) and/or the back (9) when they pass in front of the glue application nozzles (25).

23. The folding module according to claim 21, wherein the glue application module (14) is located substantially above the second roller (18b) and is fixed.

24. A machine (1) for producing at least one mailing cover (2) comprising at least one envelope document (4) made of a front (7) and a back (9) delimited by a folding line (C), one at least of the front (7) or of the back (9) comprising straight side edges (23) or side flaps (8), and the machine comprises a folding module (13) according to claim 15.

25. The machine according to claim 24, wherein the machine comprises a first routing module (5) and a second routing module (6) arranged in parallel and upstream of the folding module (13) and arranged for forwarding respectively at least one content document (3) and at least one envelope document (4).

26. The machine according to claim 25, wherein the machine comprises an assembling module (11) located downstream of the routing modules (5, 6) and upstream of the folding module (13) and arranged for assembling the at least one content document (3) on the envelope document (4).

27. The machine according to claim 24, wherein the machine comprises a glue application module (14) located upstream or downstream of the folding module (13) and arranged for applying at least one strip of glue (24) respectively on the side edges or on the side flaps (8) of the envelope document (4).

28. The machine according to claim 26, wherein the machine comprises a fold-down module (12) integrated in the assembling module (11) and arranged for folding down towards the inside side flaps (8) of the envelope document (4).
